(19) United States
(12) Patent Application Publication
(10) Pub. No.: US 2015/0195011 A1
(43) Pub. Date: Jul. 9, 2015

(54) Coupling System for use in Automation Technology

(71) Applicant: Endress + Hauser GmbH + Co. KG, Maulburg (DE)

(72) Inventors: Eric Birgel, Schopfheim (DE); Niels Donkers, Schopfheim (DE); Immanuel Vetter, Sinzheim (DE)

(21) Appl. No.: 14/409,103

(22) PCT Filed: Jun. 7, 2013
(86) PCT No.: PCT/EP2013/061784

§ 371 Date: Dec. 18, 2014

(30) Foreign Application Priority Data
Jun. 22, 2012 (DE) 10 2012 105 463.0

(51) Int. Cl. H04B 5/00; H04B 1/3888

(52) U.S. Cl. CPC H04B 5/0037; H04B 5/0075; H04B 1/3888

(57) ABSTRACT

A coupling system for use in automation technology, comprising at least a first device as well as a second device arranged outside of the first device, wherein the first device and the second device utilize a corresponding interface for wireless data and/or energy transmission, and wherein there is arranged on the first device at least a first coupling apparatus, which interacts with a second coupling apparatus of the second device. The second device with the assistance of the first coupling apparatus and the second coupling apparatus is securable releasably to the first device.

The invention relates to a coupling system for use in automation technology, for coupling a first device mechanically releasably to a second device.

In process automation technology, field devices are often applied, which serve for registering and/or influencing process variables. Serving for registering process variables are sensors, such as, for example, fill level measuring devices, flow measuring devices, pressure and temperature measuring devices, pH-redox potential measuring devices, conductivity measuring devices, etc., which register the corresponding process variables, fill level, flow, pressure, temperature, pH-value and conductivity, respectively. Serving for influencing process variables are actuators, such as, for example, valves or pumps, via which the flow of a liquid in a pipeline section, respectively the fill level in a container, can be changed. Referred to as field devices are, in principle, all devices, which are applied near to the process and deliver, or process, process relevant information. Besides these sensors and actuators, also referred to as field devices are generally any units connected directly to a fieldbus and serving for communication with superordinated units, thus units such as e.g. remote I/Os, gateways, linking devices and wireless adapters. A large number of such field devices are produced and sold by the Endress+Hauser group of companies.

Besides wired data transmission between a first device, for example, a field device, and a second device, for example, a reading and/or writing device, there is also the opportunity for a wireless transmission of data and/or energy. For this, newer devices tend to be equipped with a corresponding, integral, radio unit.

Furthermore, different standards have been created for wireless data transmission. Thus, there is, for example, an international transmission standard for near field communication (NFC) for the exchange of data and/or energy. In such case, there occurs via magnetic fields an inductive coupling or near field coupling, with the help of which an exchange of data and/or energy over short distances of a few centimeters is possible. The data transmission and often also the energy supply between a field device and a reading and/or writing device or a display device occurs, in such case, via a magnetic near field, which is implemented by coils, which serve as radio unit, respectively antennas. The frequencies used in such transmission lie at 135 kHz, respectively 13.56 MHz and are set by the standards, ISO 18000-2 and ISO 18000-3, respectively ISO 22536. Furthermore, it is known to utilize electromagnetic dipole fields for remote coupling. In such case, the data transmission and often also the energy supply via occurs antennas, for example, dipole antennas or spiral antennas. The frequencies, at which this coupling occurs, lie at 433 MHz, 868 MHz and 2.45 GHz, which are set by the standards, ISO 18000-7, ISO18000-6, respectively ISO 18000-4.

These conventional wireless communication methods, especially the NFC method, have, however, the disadvantage that the two devices must be arranged close together for the duration of the wireless, bidirectional, data and/or energy transmission. Typically, the two radio units are separated from one another by only a few centimeters. Thus, the operator is compelled to position and hold at least one of the two devices for the duration of the connection manually on the correspondingly other device. A typical case of application is the parametering, respectively configuration, of a field device by means of a portable, respectively mobile, reading and/or writing device, respectively handheld servicing device, for example, a smartphone.

An object of the invention is to provide a system for use in automation technology and distinguished by increased user friendliness in the case of wireless data and/or energy transmission between two devices.

The object is achieved according to the invention by coupling system for use in automation technology and comprising at least a first device, especially a field device, as well as a second device arranged outside of the first device, especially a reading and/or writing device and/or a handheld servicing device and/or a display device, such as, for example, a smart phone, wherein the first device and the second device utilize a corresponding interface for wireless data and/or energy transmission and wherein there is arranged on the first device at least a first coupling apparatus, which interacts with a second coupling apparatus of the second device, wherein the second device with the assistance of the first coupling apparatus and the second coupling apparatus is securable releasably to the first device.

According to the invention, the increased user friendliness is achieved by a coupling system, which makes it possible for the operator to position and/or to hold two devices of automation technology for the purpose of wireless data and/or energy transmission corresponding to the requirements of the transmission technology. Provided for this on the first device, especially a field device, is a first coupling apparatus, with which a second coupling apparatus of the second device, especially a smart phone, is capable of being coupled in such a manner that the two devices can communicate with one another by means of wireless data and/or energy transmission. After terminating the wireless communication, in this way, the two mutually coupled devices, respectively secured or mounted to one another, can be released from one another.

Another advantageous embodiment of the coupling system of the invention provides that the center region of the first coupling apparatus of the first device has at least a first component for coupling/interaction.

Another advantageous embodiment of the coupling system provides that the first coupling apparatus has at least one other component, preferably, however, a number, of other components, arranged in the edge region for coupling/interaction.

In this way, the coupling stability, respectively holding force, for the coupling of the second device via the coupling apparatus to the first device can be significantly increased.

Especially advantageous in connection with the coupling system of the invention is that in the case, in which the first coupling apparatus of the first device has a number of components, these are embodied essentially equidistantly around the first component. Because the additional components of the edge region are arranged essentially equidistantly around the at least first component of the center region, a second device coupled, in this way, on the first device can be rotated, respectively turned relative to the first device, virtually rotationally symmetrically to the midpoint of the first component. This offers for an operator, for example, the opportunity, so to orient the coupled second device, which serves, for example, as a display device, that the display of the display device is individually positionable as regards its viewing angle.

In an additional advantageous embodiment of the coupling system of the invention, it is provided that the center region of the second coupling apparatus of the second device has at least a second component, which interacts with the first component of the first coupling apparatus of the first device.

In another embodiment, the coupling system of the invention is constructed such that the second coupling apparatus of the second device has at least one other component, preferably, however, a number of other components, arranged in the edge region and interacting with the number of additional components of the first coupling apparatus of the first device. In this way, as already mentioned, the stability of the coupling of the second device to the first device via the coupling apparatus can be significantly increased in comparison with the embodiment with only one, respectively at least one, first component formed in the center region of the first coupling apparatus.

In an additional embodiment, the coupling system of the invention is embodied such that the, preferably, number of additional components of the second coupling apparatus of the second device are embodied in such a manner that they are arranged essentially equidistantly around the center region of the second coupling apparatus. In this way, the two mutually coupled devices can be rotated, respectively turned, relative to one another as a function of the number of additional components.

In an additional advantageous embodiment of the coupling system of the invention, it is provided that the components of the second coupling apparatus of the second device are arranged corresponding to the components of the first coupling apparatus of the first device.

An alternative embodiment of the coupling system of the invention provides that the first coupling apparatus of the first device magnetically interacts with the second coupling apparatus of the second device. In this way, the second device coupled with the first device can be released in an especially user friendly manner, i.e. especially without an extra tool.

Another alternative embodiment of the coupling system of the invention provides that the components of the first coupling apparatus of the first device or the components of the second coupling apparatus of the second device are embodied as permanent magnets, especially neodymium magnets and/or ferrite magnets.

A last alternative embodiment of the coupling system of the invention provides that the components of the first coupling apparatus of the first device and the components of the second coupling apparatus of the second device are embodied as permanent magnets, especially neodymium magnets and/or ferrite magnets of different polarity.

The invention will now be explained in greater detail based on the appended drawing, the sole FIGURE of which shows as follows:

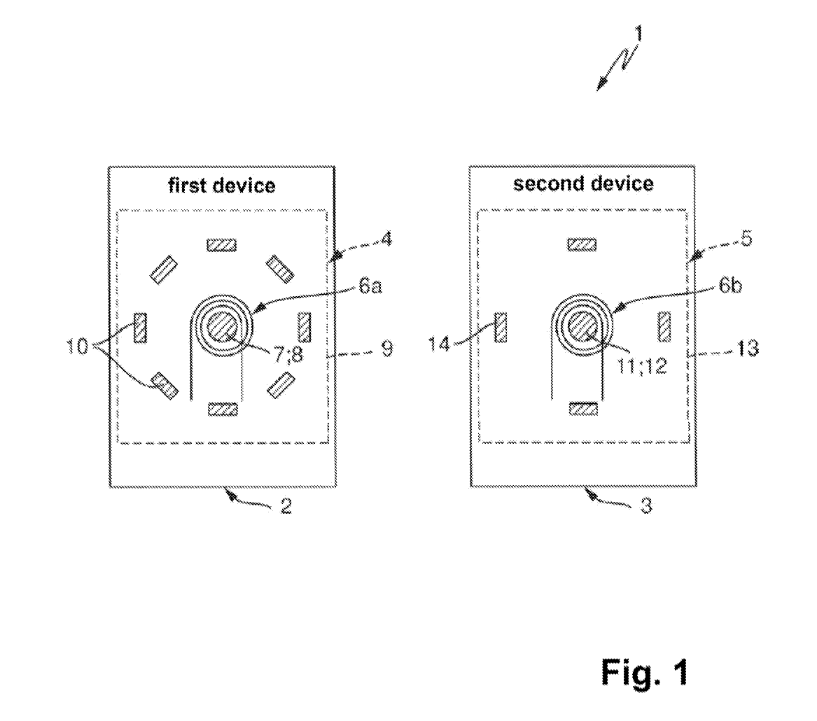

FIG. 1 a schematic representation of a preferred embodiment of the coupling system of the invention.

FIG. 1 shows a schematic representation of a preferred embodiment of the coupling system 1 of the invention. Coupling system 1 is composed of a first device 2, especially a field device 2, and a second device 3 arranged separately outside of the first device 2, especially a smart phone 3, wherein the two devices 2, 3 can be mechanically coupled to one another with the assistance of the coupling system 1 for the duration of the wireless energy and/or data transmission. For this, a first coupling apparatus 4 is provided on the first device 2 and a second coupling apparatus 5 on the second device 3.

Furthermore, the two devices have for wireless data and/or energy transmission the correspondingly required interfaces 6a, 6b, especially radio units, respectively antennas, which are embodied in such a manner that they are located in the immediate vicinity of the coupling apparatuses 4, 5. It depends on the communication method, whether the interfaces 6a, 6b are arranged in the region of the coupling apparatus 4, 5 or in given cases separated therefrom. For using near field communication (NFC) for wireless data and/or energy transmission, it has proven to be especially advantageous to arrange the interfaces 6a, 6b in the, respectively around the, center regions 7, 11 of the two coupling apparatuses 4, 5. Ideally, the interface 6a, 6b of the respective device 2, is arranged around the first component 8, 12 of the corresponding coupling apparatus 4, 5. Other options include, however, also, arranging the interface 6a, 6b separated from the center region 7, 11 and, in given cases, also from the coupling apparatus 4, 5.

With the help of the interfaces 6a, 6b for wireless data and/or energy transmission, the two devices 2, 3 can communicate with one another, wherein the coupling system 1 cares for mechanical coupling, respectively affixing, of the two devices 2, 3 during communication, and, after the communication ends, the two devices 2, 3 can be released from one another. In this way, the first device 2, which especially represents a field device 2, and the second device 3, which especially represents a smart phone 3 with corresponding software, respectively app or apps, can exchange data and/or energy.

An example of an application is the configuring and/or parametering of the field device 2 with the assistance of a smartphone 3, wherein the smart phone 3 with a corresponding software, respectively with a corresponding APP, serves as operating, or servicing, tool for configuring and/or parametering of the field device 2 and with the assistance of the coupling system 1 is coupled during the wireless configuring and/or parametering mechanically with the field device 2.

Another example of application is the displaying, respectively visualizing of data, respectively information, of a field device 2, which has no integrated display device. For this, the second device 3, which functions as an external display device, is with the assistance of the coupling system mechanically coupled to the field device 2 and, thus, enables the operator, for example, a service technician, to read-out data, respectively information, from the field device 2. In such case, the external display device can be supplied with the energy needed for operation either by its own energy source or, alternatively, via the wireless communication method, especially by means of near field communication (NFC).

As already mentioned, it is for the wireless data transmission necessary to arrange the two communicating devices 2, 3 in such a manner that the two interfaces, respectively radio units, 6a, 6b are spaced from one another by only a few centimeters. For this, the second device 3 is releasably coupled to the first coupling apparatus 4 of the first device 2 by means of the second coupling apparatus 5.

The first coupling apparatus 4 includes in its center region at least a first component 8, which is provided for coupling, respectively interacting, with a second component 12 of the second coupling apparatus 5 of the second device 3. The second component 12 is likewise embodied in the center region 11 of the second coupling apparatus 5 and embodied in such a manner that it can interact with the first component 8. For this, at least one of the two components 8, 12 has a magnetic field, with the assistance of which the other corresponding component 12, 8 is capable of being coupled. An especially preferred variant is that in which both components 8, 12 are permanent magnets, for example, neodymium magnets and/or ferrite magnets, with different polarities. Another alternative solution provides that only one of the two components 8, 12 is a permanent magnet and the other component 12, 8 is composed of a ferromagnetic material, for example, a metal platelet, respectively component.

A second device 3 secured, respectively coupled, in this way to the first device 2 can, after, respectively during, the coupling be positioned as desired by rotation of the second device 3 relative to the first device 2. Thus, for example, the operator, especially a service technician, can position a smart phone 3 coupled to the field device 2 according to the particular situation, in order to provide a convenient reading of the display of the smartphone 3.

In order to achieve an increased stability of the coupling, there is provided in the edge regions 9, 13 of the two coupling apparatuses 4, 5, in each case, at least one other component 10, 14, wherein the at least one other component 10 can be embodied in the form of a platelet or, such as not shown in FIG. 1, in the form of a ring, wherein the ring essentially covers, respectively is arranged in, the edge region 9 of the first coupling apparatus 4.

Of course, also a combination of the two is possible, wherein, for example, the one coupling apparatus 4, 5 has a further component 10, 14 in the form of a ring and the other coupling apparatus 5, 4 has a number of individual components 14, 10, which are arranged in the edge region 9, 13 of the corresponding coupling apparatus 4, 5, or the two coupling apparatuses each have a ring as a further component.

The first coupling apparatus 4 shown in FIG. 1 has eight other components 10 in the edge region 9, which are arranged essentially equidistantly around the first component 8 of the first coupling apparatus 4. In contrast the second coupling apparatus 5 is embodied in such a manner that it has four other components 14 in the edge region 13, which likewise are arranged essentially equidistantly around the second component 12 of the second coupling apparatus 5. These four additional components 14 of the second coupling apparatus 5 can be coupled to the additional components 10 of the first coupling apparatus 4.

Because of the fact that both of the additional components 10 of the first coupling apparatus 4 as well as also the additional components 14 of the second coupling apparatus 5 are arranged essentially equidistantly around the respective first component 8, 12 and, moreover, the additional components 14 of the second coupling apparatus 5 are arranged relative to the additional components 10 of the first coupling apparatus 4 corresponding, especially relative, to its separation from the respective first component 8, 12, a rotation of the second device 3 relative to the first device 2 is possible.

The number of additional components 10, 14 of the two coupling apparatuses 4, 5 determine the step angle, with which the second device 3 can be rotated relative to the first device 2. With the coupling system 1 illustrated in FIG. 1, the two devices 2, 3 can be rotated, respectively turned, with a step angle of 45° relative to one another. The number of additional components 10 of the first coupling apparatus can be increased or, in given cases, also decreased, in order to achieve a greater, respectively lesser, step angle.

### LIST OF REFERENCE CHARACTERS

1 coupling system for use in automation technology
2 first device of automation technology/field device
3 second device of automation technology/smart phone
4 first coupling apparatus
5 second coupling apparatus
6a,6b interface for wireless data and/or energy transmission
7 center region of the first coupling apparatus
8 first component of the first coupling apparatus
9 edge region of the first coupling apparatus
10 component of the first coupling apparatus
11 center region of the second coupling apparatus
12 second component of the second coupling apparatus
13 edge region of the second coupling apparatus
14 component of the second coupling apparatus

1-11. (canceled)

12. A coupling system for use in automation technology, comprising:
at least a first device; and
a second device arranged outside of said first device, wherein:
said first device and said second device utilize a corresponding interface for wireless data and/or energy transmission;
there is arranged on said first device at least a first coupling apparatus, which interacts with a second coupling apparatus of said second device; and
said second device with the assistance of said first coupling apparatus and said second coupling apparatus is securable releasably to said first device.

13. The coupling system as claimed in claim 12, wherein:
the center region of said first coupling apparatus of said first device has at least a first component for coupling/interaction.

14. The coupling system as claimed in claim 12, wherein:
said first coupling apparatus has at least one other component, preferably, however, a number of other components, arranged in an edge region for coupling/interaction.

15. The coupling system as claimed in claim 14, wherein:
in the case, in which said first coupling apparatus of said first device has a number of components, these are embodied essentially equidistantly around a first component.

16. The coupling system as claimed in claim 12, wherein:
a center region of said second coupling apparatus of said second device has at least a second component, which interacts with a first component of said first coupling apparatus of said first device.

17. The coupling system as claimed in claim 12, wherein:
said second coupling apparatus of said second device has at least one other component, preferably, however, a number of other components, arranged in an edge region and interacting with the additional components of said first coupling apparatus of said first device.

18. The coupling system as claimed in claim 17, wherein;
the, preferably, number of additional components of said second coupling apparatus of said second device are embodied in such a manner that they are arranged essentially equidistantly around a center region of said second coupling apparatus.

19. The coupling system as claimed in claim 12, wherein:
said components of said second coupling apparatus of said second device are arranged corresponding to the components of said first coupling apparatus of said first device.

20. The coupling system as claimed in claim 12, wherein:
said first coupling apparatus of said first device magnetically interacts with said second coupling apparatus of said second device.

21. The coupling system as claimed in claim 12, wherein:
said components of said first coupling apparatus of said first device or said components of said second coupling apparatus of said second device are embodied as permanent magnets.

22. The coupling system as claimed in claim 12, wherein:
said components of said first coupling apparatus of said first device and said components of said second coupling apparatus of said second device are embodied as permanent magnets of different polarity.
